(19) United States
(12) Patent Application Publication
(10) Pub. No.: US 2011/0315321 A1
(43) Pub. Date: Dec. 29, 2011

(54) RESIN APPLICATION APPARATUS AND DATA CREATION APPARATUS FOR RESIN APPLICATION

(75) Inventors: Seiichi Yoshinaga, Yamanashi (JP); Tadahiko Sakai, Osaka (JP)

(73) Assignee: PANASONIC CORPORATION, Osaka (JP)

(21) Appl. No.: 13/201,015

(22) PCT Filed: Jan. 25, 2010
(86) PCT No.: PCT/JP2010/000406

§ 371 Date: Aug. 11, 2011

(30) Foreign Application Priority Data
Feb. 20, 2009 (JP) 2009-037488

(51) Int. Cl. B05C 5/00

(52) U.S. Cl. 156/356

(57) ABSTRACT

An object of the invention is to provide a resin application apparatus capable of efficiently doing resin application work for resin reinforcement for which a corner part of an electronic component is targeted, and a data creation apparatus for resin application.

In the resin application apparatus for linearly applying a resin for reinforcement along an outer edge of the electronic component in an electronic component mounting body in which the electronic component is mounted on a substrate, component position information indicating a position of the electronic component in the electronic component mounting body, component information including a side size of the electronic component and a basic pattern with an application shape for forming a corner reinforced part disposed in the corner part are stored in a storage part (31) and dimension data indicating a concrete dimension in the basic pattern is inputted through an input part (35) and thereby, application locus data for applying the resin for reinforcement is computed by a locus computation part (32). Consequently, the resin application work for resin reinforcement for which the corner part of the electronic component is targeted can be done efficiently.

### TECHNICAL FIELD

The present invention relates to a resin application apparatus for linearly applying a resin for reinforcement along an outer edge of an electronic component in an electronic component mounting body made by mounting the electronic component on a substrate, and a data creation apparatus for resin application for creating data for resin application used in this resin application apparatus.

### BACKGROUND ART

As a method for mounting an electronic component on a substrate, the method by soldering is widely used and by soldering an electrode for connection disposed in the electronic component to an electrode of the substrate, the electronic component conducts electrically to the substrate and also the electronic component after mounting is held to the substrate by a soldered part. When an external force such as thermal stress by a heat cycle acts on the electronic component in a use state after mounting, strength is poor in only the soldered part, so that a holding force by the soldered part is reinforced by bonding the electronic component to the substrate by a resin for reinforcement together with the soldering (see Patent Reference 1).

In the related art shown in this Patent Reference example, an under fill resin is injected and cured over the whole periphery of the electronic component in only a gap located in the outermost periphery of the electronic component among the gap between the electronic component and the substrate after the electronic component having a group of bumps on a lower surface is soldered to the substrate through the bumps.

However, the following problem occurs in a method for forming a resin reinforced part by injecting and curing the under fill resin over the whole periphery of the electronic component as shown in the Patent Reference example described above. That is, in this resin reinforcing method, the gap between the substrate and the lower surface of the electronic component becomes hermetically sealed space dosed completely, so that moisture or an organic substance remaining inside the gap vaporizes by heating when the substrate after mounting is again heated. Consequently, a pressure of the inside of the gap increases and a crack occurs in the resin reinforced part thermally cured already by the internal pressure and trouble of reducing reliability of mounting may be caused.

As a result of this, a resin reinforcing method of a form of limiting formation of the resin reinforced part to a corner part of the electronic component is being used. Consequently, the gap between the substrate and the lower surface of the electronic component can be communicated to the outside while reinforcing the corner part which is the most critical portion in strength in the heat cycle.

### PRIOR ART REFERENCE

### Patent Reference

Patent Reference 1: JP-A-2002-16192

### DISCLOSURE OF THE INVENTION

### Problems that the Invention is to Solve

However, there was the following problem in the case of adopting the resin reinforcing method of the form of being limited to the corner part of the electronic component as described above. That is, in this resin application method, a resin is applied to a region specified as an application target region with respect to each of the corner parts in an application operation of the resin for reinforcement. Such resin application is normally performed by drawing application for moving an application nozzle while discharging the resin for reinforcement from the application nozzle, but it is necessary to previously create data of a drawing locus of moving the application nozzle in this drawing application. But, a conventional resin application apparatus did not have a function of efficiently creating the data for the drawing application for the purpose of resin reinforcement for which such a corner part is targeted.

Therefore, an object of the invention is to provide a resin application apparatus capable of efficiently doing resin application work for resin reinforcement for which a corner part of an electronic component is targeted, and a data creation apparatus for resin application.

### Means for Solving the Problems

A resin application apparatus of the invention is the resin application apparatus for linearly applying a resin for reinforcement along an outer edge of an electronic component in an electronic component mounting body in which the electronic component having a planar shape of a rectangle is mounted on a substrate or the substrate before the electronic component is mounted, and the resin application apparatus includes a resin discharge unit for discharging the resin for reinforcement from a discharge orifice of an application nozzle, a movement unit for moving the application nozzle relatively to the electronic component mounting body, a position information storage part for storing component position information indicating a position of the electronic component in the electronic component mounting body, a component information storage part for storing component information including a side size of the electronic component, a basic pattern storage part for storing plural basic patterns with application shapes for forming four corner reinforced parts disposed in each of four corner parts in the rectangle, an input part for inputting dimension data indicating a concrete dimension in the basic pattern, a locus computation part for computing application locus data for moving the application nozzle and applying the resin for reinforcement based on the position information, the component information, the basic patterns and the dimension data, and an application operation control part for controlling the resin discharge unit and the movement unit based on the application locus data, and the corner reinforced part is constructed by a first resin line set in parallel with one side of four sides in the rectangle and formed by applying the resin for reinforcement along a first application line including the corner part, and a second resin line set in parallel with the other side orthogonal to the one side and formed by applying the resin for reinforcement along a second application line including the corner part, and length dimensions of the first resin line and the second resin line are inputted as the dimension data.

A data creation apparatus for resin application of the invention is the data creation apparatus for resin application, including a resin discharge unit for discharging a resin for reinforcement from a discharge orifice of an application nozzle, a movement unit for moving the application nozzle relatively to an electronic component mounting body in which an electronic component having a planar shape of a rectangle is mounted on a substrate or the substrate before the electronic component is mounted, and an application operation control part for controlling the resin discharge unit and the movement unit, the data creation apparatus which is used in a resin application apparatus for linearly applying the resin for reinforcement along an outer edge of the electronic component in the electronic component mounting body or the substrate before the electronic component is mounted and creates application locus data for moving the application nozzle and applying the resin for reinforcement, and the data creation apparatus includes a position information storage part for storing component position information indicating a position of the electronic component in the electronic component mounting body, a component information storage part for storing component information including a side size of the electronic component, a basic pattern storage part for storing plural basic patterns with application shapes for forming four corner reinforced parts disposed in each of four corner parts in the rectangle, an input part for inputting dimension data indicating a concrete dimension in the basic pattern, and a locus computation part for computing the application locus data for moving the application nozzle and applying the resin for reinforcement based on the position information, the component information, the basic patterns and the dimension data, and the corner reinforced part is constructed by a first resin line set in parallel with one side of four sides in the rectangle and formed by applying the resin for reinforcement along a first application line including the corner part, and a second resin line set in parallel with the other side orthogonal to the one side and formed by applying the resin along a second application line including the corner part, and length dimensions of the first resin line and the second resin line are inputted as the dimension data.

### Advantage of the Invention

According to the invention, resin application work for resin reinforcement for which the corner part of the electronic component is targeted can be done efficiently by adopting a configuration in which the component position information indicating the position of the electronic component in the electronic component mounting body, the component information including the side size of the electronic component and the basic pattern with the application shape for forming the corner reinforced part disposed in the corner part are stored and the dimension data indicating the concrete dimension in the basic pattern is inputted and thereby the application locus data for moving the application nozzle and applying the resin for reinforcement is computed.

### BRIEF DESCRIPTION OF THE DRAWINGS

FIG. 1 is a perspective diagram of a resin application apparatus of one embodiment of the invention.

FIG. 2 is a configuration explanatory diagram of an electronic component mounting body targeted for application of the resin application apparatus of one embodiment of the invention.

FIGS. 3(a) to 3(c) are explanatory diagrams showing basic patterns of a corner reinforced part in the electronic component mounting body of one embodiment of the invention.

FIGS. 4(a) and 4(b) are explanatory diagrams showing a shape of the corner reinforced part in the electronic component mounting body of one embodiment of the invention.

FIGS. 5(a) to 5(c) are explanatory diagrams showing a shape of a corner reinforced part in the electronic component mounting body of one embodiment of the invention.

FIGS. 6(a) and 6(b) are explanatory diagrams showing a shape of a corner reinforced part in the electronic component mounting body of one embodiment of the invention.

FIG. 7 is an explanatory diagram showing a shape of a corner reinforced part in the electronic component mounting body of one embodiment of the invention.

FIG. 8 is a block diagram showing a configuration of a control system of the resin application apparatus of one embodiment of the invention.

FIGS. 9(a) and 9(b) are explanatory diagrams of dimension data indicating concrete dimensions of the corner reinforced part in a resin application method of one embodiment of the invention.

FIG. 10 is a flow diagram explaining application work processing of a resin for corner reinforcement of one embodiment of the invention.

FIG. 11 is a flow diagram of locus check processing in the application work processing of the resin for corner reinforcement of one embodiment of the invention.

FIGS. 12(a) to 12(d) are step explanatory diagrams showing an application method of the resin for corner reinforcement of one embodiment of the invention.

FIGS. 13(a) to 13(d) are step explanatory diagrams showing the application method of the resin for corner reinforcement of one embodiment of the invention.

### MODE FOR CARRYING OUT THE INVENTION

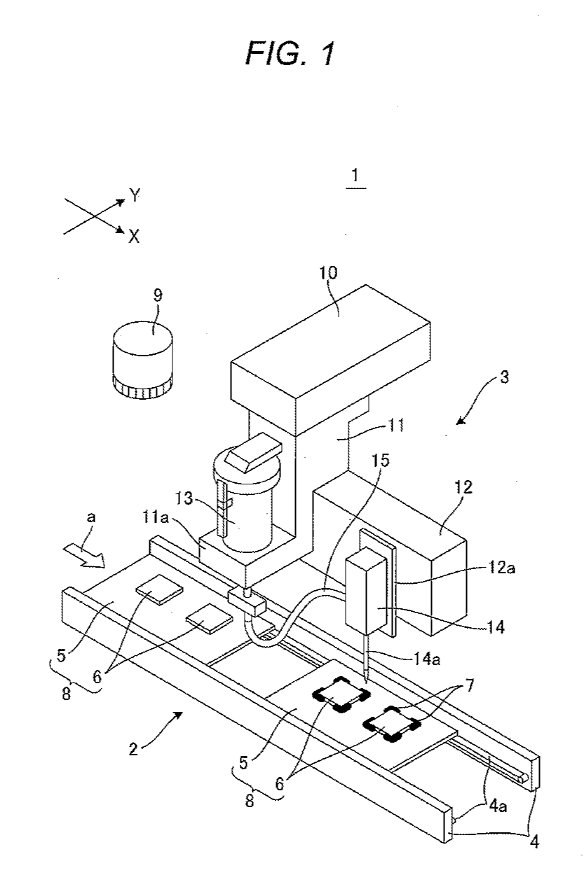

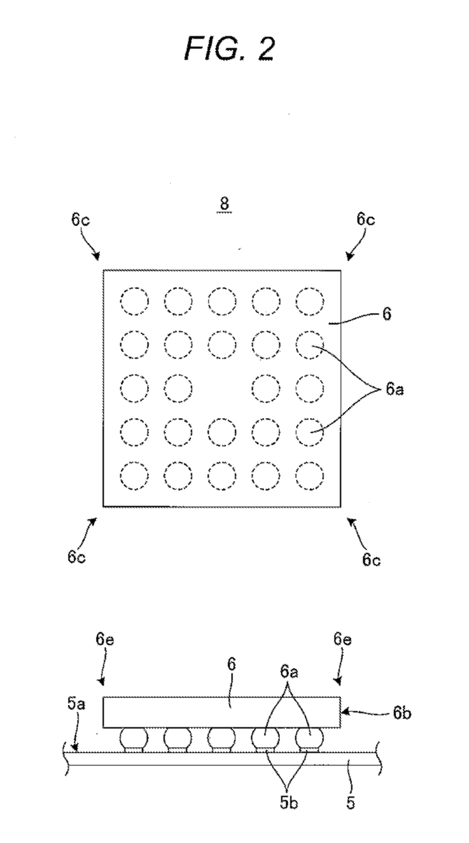

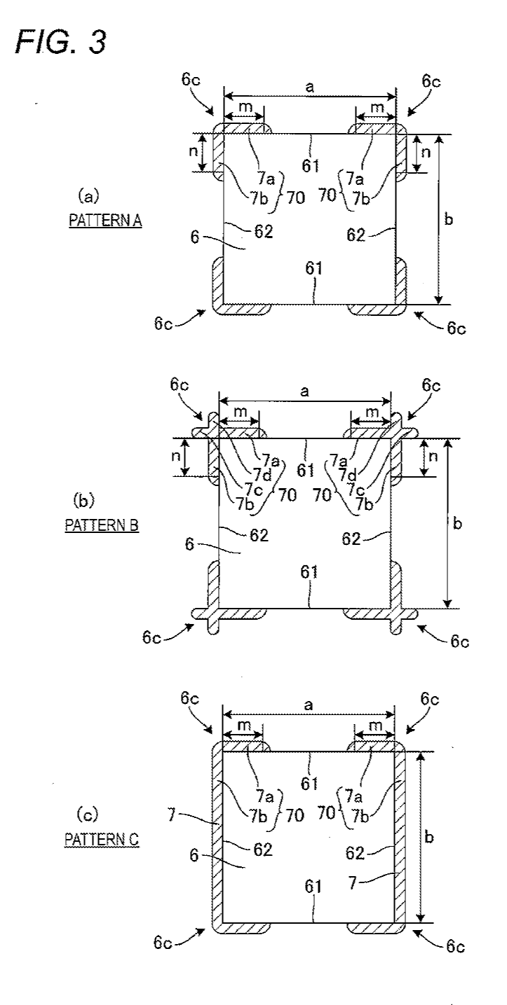

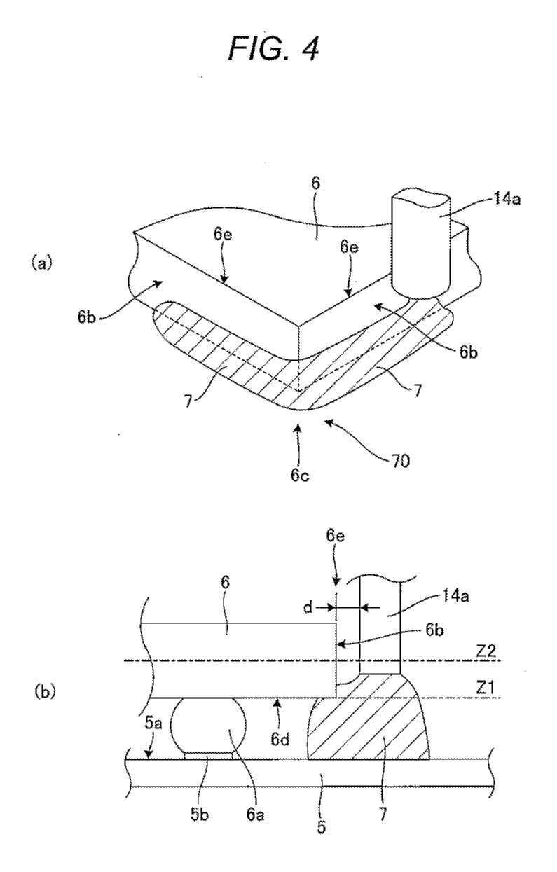

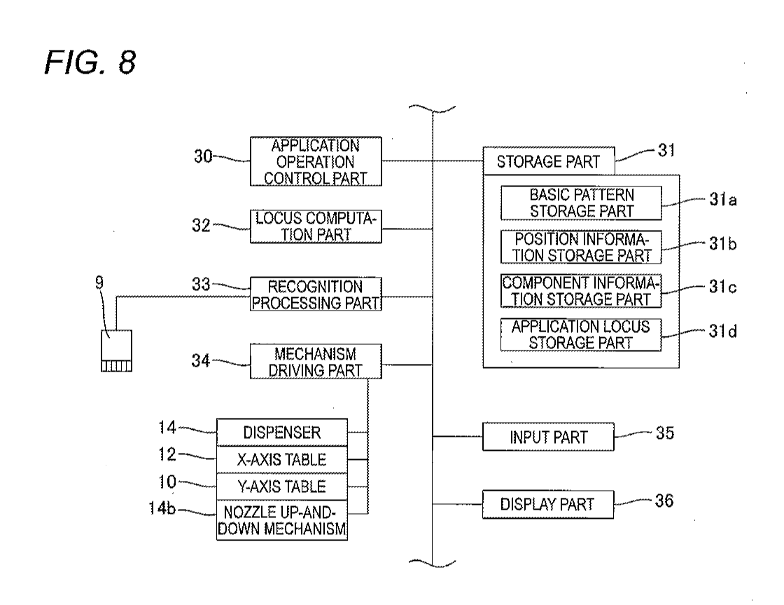

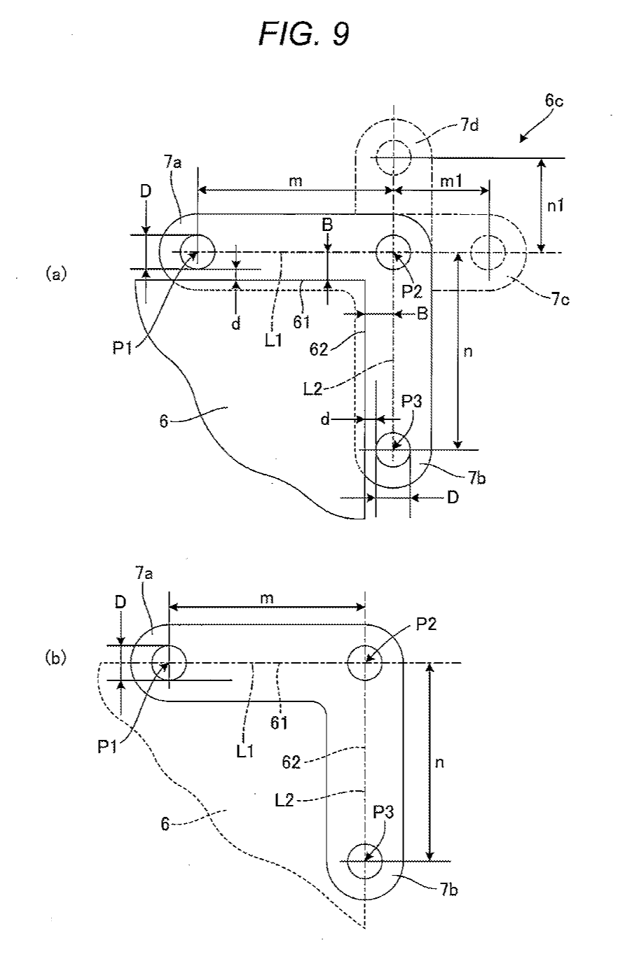

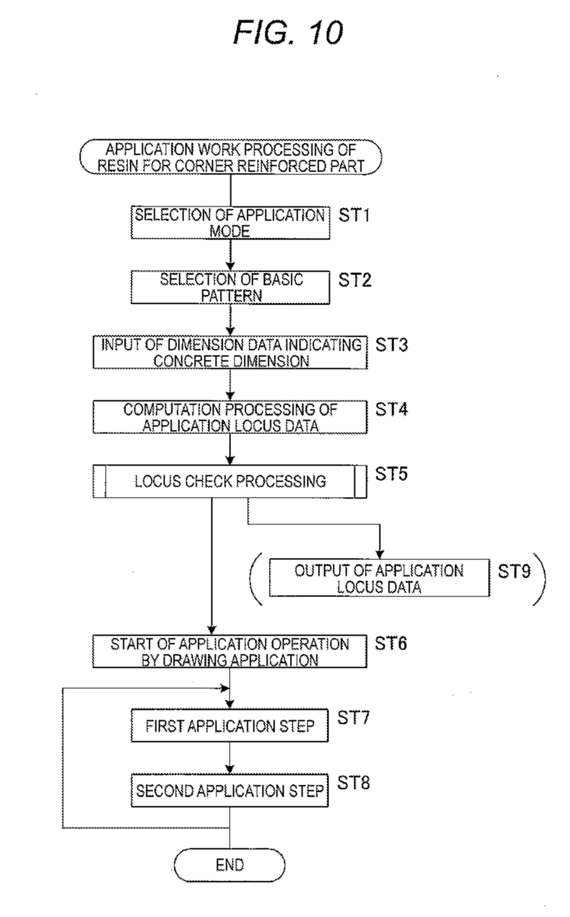

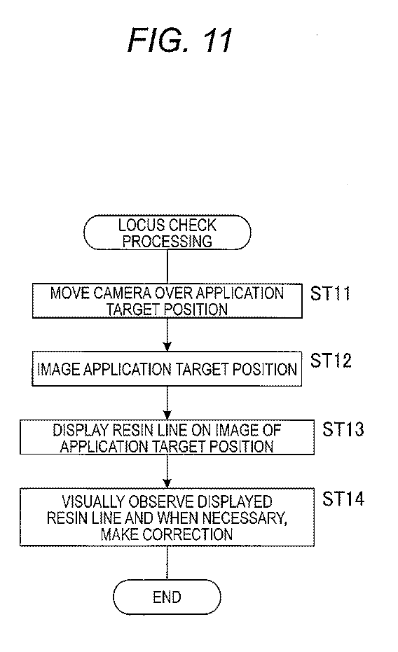

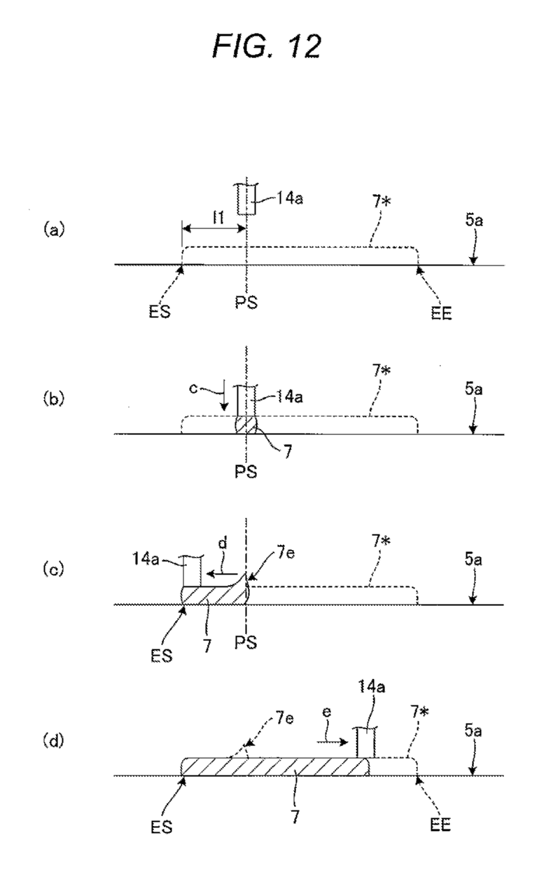

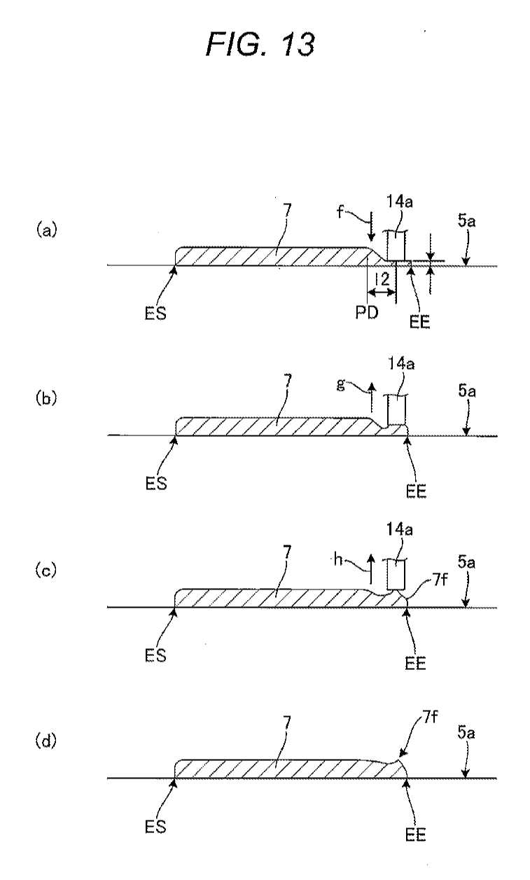

Next, an embodiment of the invention will be described with reference to the drawings. FIG. 1 is a perspective diagram of a resin application apparatus of one embodiment of the invention, and FIG. 2 is a configuration explanatory diagram of an electronic component mounting body targeted for application of the resin application apparatus of one embodiment of the invention, and FIG. 3 is explanatory diagrams showing basic patterns of a corner reinforced part in, the electronic component mounting body of one embodiment of the invention, and FIGS. 4, 5, 6 and 7 are explanatory diagrams showing shapes of the corner reinforced parts in the electronic component mounting body of one embodiment of the invention, and FIG. 8 is a block diagram showing a configuration of a control system of the resin application apparatus of one embodiment of the invention, and FIG. 9 is explanatory diagrams of dimension data indicating concrete dimensions of the corner reinforced part in a resin application method of one embodiment of the invention, and FIG. 10 is a flow diagram explaining application work processing of a resin for corner reinforcement of one embodiment of the invention, and FIG. 11 is a flow diagram of locus check processing in the application work processing of the resin for corner reinforcement of one embodiment of the invention, and FIGS. 12 and 13 are step explanatory diagrams showing an application method of the resin for corner reinforcement of one embodiment of the invention.

First, a structure of a resin application apparatus 1 will be described with reference to FIG. 1. The resin application apparatus 1 has a function of linearly applying a resin for reinforcement along an outer edge of an electronic component in an electronic component mounting body in which the electronic component having a planar shape of a rectangle and having a bump for connection on a lower surface is mounted. The resin application apparatus 1 has a conveyance part 2 for conveying the electronic component mounting body targeted for application and a resin application part 3 which is disposed in a lateral portion of the conveyance part 2 and discharges a resin as main constituent elements.

In FIG. 1, the conveyance part 2 includes a pair of conveyance rails 4 respectively including conveyors 4a, and an electronic component mounting body 8 in which electronic components 6 with bumps are previously mounted on a substrate 5 in a previous step of the upstream side (arrow a) is conveyed in a substrate flow direction (X direction). In the conveyed electronic component mounting body 8, resins 7 for reinforcement for reinforcing a holding force for holding the electronic components 6 in the substrate 5 are applied to four corner parts (see corner parts 6c shown in FIG. 3) of each of the electronic components 6. A camera 9 whose imaging surface is turned downward is disposed over the conveyance part 2, and a shape or a position of the electronic component 6 on the substrate 5 can be recognized by imaging the electronic component mounting body 8 by the camera 9.

A configuration of the resin application part 3 will be described. In a lower surface of a Y-axis table 10, a coupling bracket 11 is disposed movably in a Y direction and an X-axis table 12 is coupled to the coupling bracket 11. Also, a resin tank 13 is attached to a holding base 11a disposed in a state of extending over the conveyance part 2 from a lower portion of the coupling bracket 11. The resin tank 13 has a function of accumulating the resin 7 for reinforcement targeted for application and supplying the resin 7 to the following dispenser 14 by a prescribed amount. The dispenser 14 in which an application nozzle 14a protruding downward is disposed in the lower end is attached to a movement table 12a disposed in a side surface of the side of the conveyance part 2 in the X-axis table 12.

The dispenser 14 is connected to the resin tank 13 through a resin supply tube 15, and the resin 7 for reinforcement supplied from the resin tank 13 is supplied to the dispenser 14 through the resin supply tube 15 and is discharged from the application nozzle 14a by the prescribed amount at predetermined timing. The dispenser 14 moves in the X direction and the Y direction over the conveyance part 2 by driving the Y-axis table 10 and the X-axis table 12. The resin tank 13 and the dispenser 14 construct resin discharge unit for discharging the resin 7 for reinforcement from a discharge orifice of the application nozzle 14a.

The dispenser 14 incorporates a nozzle up-and-down mechanism 14b (see FIG. 8) for moving up and down the application nozzle 14a, and when the resin 7 for reinforcement is applied to the electronic component mounting body 8, the dispenser 14 is moved according to a prescribed application locus by the Y-axis table 10 and the X-axis table 12 in a state of positioning the discharge orifice of the application nozzle 14a at a predetermined application height. Consequently, corner reinforced parts 70 (see FIG. 3) in which resin lines of the resins 7 for reinforcement are formed along an outer edge 6e of the electronic component 6 in the corner parts 6c of the electronic component 6 are formed in the electronic component mounting body 8. The Y-axis table 10, the X-axis table 12 and the nozzle up-and-down mechanism incorporated into the dispenser 14 construct movement unit for moving the application nozzle 14a relatively to the electronic component mounting body 8.

Next, the electronic component mounting body 8 will be described with reference to FIG. 2. The electronic component mounting body 8 is made by mounting plural electronic components on a substrate by soldering, and an example of applying an electronic component mounting structure of a configuration in which the electronic component 6 having a planar shape of a rectangle and having bumps 6a as two electrodes for connection is mounted on the substrate 5 by soldering through the bumps 6a is shown herein. That is, plural electrodes 5b are formed on an upper surface 5a of the substrate 5 in correspondence with arrangement of the bumps 6a in the electronic component 6 targeted for mounting. In the previous step, the electronic component 6 is mounted on the substrate 5 and thereby the bumps 6a are soldered to the electrodes 5b. The portion soldered to the electrodes 5b by melt of the electronic component 6 forms a soldered part in which the electrodes for connection of the electronic component 6 are soldered to the electrodes 5b disposed in the substrate 5.

In this electronic component mounting body 8, a holding force by soldering the bumps 6a to the electrodes 5b does not have the holding force sufficient for a load by a physical external force or thermal stress by a heat cycle at the time of use of a product, so that resin reinforcement for reinforcing this holding force is performed by a thermosetting resin etc. This resin reinforcement includes various forms, and the resin reinforcement by an under fill resin in which a gap between the substrate and the electronic component after mounting the electronic component is filled with a liquid thermosetting resin has been adopted conventionally.

However, it becomes difficult to be filled with the under fill resin as the gap between the substrate and the electronic component becomes narrow by miniaturization of the electronic component. Therefore, the present embodiment is constructed so that a reinforcing resin is applied to the vicinity of the corner part 6c to form the corner reinforced part 70 (FIG. 4) for the purpose of reinforcing the outer edge 6e of the electronic component 6, particularly intensively the corner part 6c in which a stress level becomes the most critical.

In the embodiment, three patterns as shown in FIG. 3 are preset as a basic pattern of the corner reinforced part 70 and these patterns are used according to reinforcement characteristics required in the electronic component mounting body 8 of a target. All the patterns A, B and C shown in FIG. 3 show the case of respectively forming the corner reinforced parts 70 with the same shape in the four corner parts 6c in the electronic component 6 of the rectangle in which lengths of two mutually orthogonal sides are respectively a and b. First, in the pattern A shown in FIG. 3(a), a first resin line 7a with a length of m and a second resin line 7b with a length of n constructing the corner reinforced part 70 are respectively formed in a first side 61 and a second side 62 with respect to the corner part 6c in which the first side 61 with the length of a is orthogonal to the second side 62 with the length of b.

The pattern B shown in FIG. 3(b) has a form of having a first resin extension part 7c and a second resin extension part 7d respectively extended by predetermined lengths in directions of the outside with respect to the corner part 6c from the first resin line 7a and the second resin line 7b in the pattern A shown in FIG. 3(a). In the pattern A and the pattern B, both of the first resin line 7a and the second resin line 7b are formed in the length less than one-half the length of each of the sides. Consequently, a resin reinforced part is not formed in the centers of the first side 61 and the second side 62 and a gap between the electronic component 6 and the upper surface 5a of the substrate 5 is constructed so as to communicate to the outside. Also, the pattern C shown in FIG. 3(c) has a form in which the resin 7 for reinforcement is continuously applied to the second side 62 in the pattern A shown in FIG. 3(a), in other words, the second resin line 7b is continuously formed with respect to the second side 62 in the pattern A.

By forming the resin reinforced part in the form in which the gap between the electronic component 6 and the substrate 5 communicates to the outside thus, trouble caused in a method for forming the resin reinforced part over the whole periphery of the electronic component can be prevented. That is, when the gap between the substrate and the lower surface of the electronic component becomes hermetically sealed space closed completely, in the case of again heating the substrate after mounting, moisture or an organic substance remaining inside the gap vaporizes by heating and a pressure of the inside of the gap increases and a crack occurs in the resin reinforced part thermally cured already by the internal pressure and trouble of reducing reliability of mounting may be caused. On the other hand, by using the reinforcement method as shown in the embodiment, gas is not closed inside the gap between the substrate and the lower surface of the electronic component and such trouble can be prevented effectively.

All the corner reinforced parts 70 shown in the patterns A, B and C shown in FIG. 3 are formed in each of the four corner parts 6c in the rectangle of the electronic component 6 by linearly applying the resin 7 for reinforcement by the application nozzle 14a along the outer edge 6e of the electronic component 6 on the upper surface 5a of the substrate 5 as shown in FIG. 4(a). Then, all these corner reinforced parts 70 have a function of bonding the electronic component 6 to the substrate 5 and reinforcing the holding force for holding this electronic component 6 in the substrate 5. That is, by linearly applying the resin 7 for reinforcement along the outer edge 6e of the rectangular electronic component 6 (one electronic component) on the upper surface 5a of the substrate 5, the corner reinforced parts 70 are formed in each of the four corner parts 6c in the rectangle of the electronic component 6 and the electronic component 6 is bonded to the substrate 5 and the holding force for holding the electronic component 6 in the substrate 5 is reinforced.

Then, each of the corner reinforced parts 70 is constructed by the first resin line 7a formed in the length less than one-half the length of the first side 61 including the corner part 6c in parallel with the first side 61 (one side) of the four sides (the first side 61, the second side 62) constructing the rectangle of the electronic component 6 and the second resin line 7b formed including the corner part 6c in parallel with the second side 62 (the other side) orthogonal to the first side 61. In addition, in the patterns A and B, the second resin line 7b is also formed in the length less than one-half the length of the second side 62, but the pattern C has a form of having the first resin line 7a formed in the length less than one-half the length of the first side 61 in only the first side 61.

In the case of forming such a corner reinforced part 70, drawing application for discharging the resin 7 for reinforcement while moving the application nozzle 14a according to a preset application locus as shown in FIG. 4(a) is used. As shown by a sectional view of FIG. 4(b), the resin 7 for reinforcement discharged from the application nozzle 14a partially intrudes into the gap between the electronic component 6 and the substrate 5, and is thermally cured in a state in which a portion of the resin 7 for reinforcement makes contact with a side surface 6b and a lower surface 6d of the electronic component 6, and the corner reinforced part 70 is formed. As the resin 7 for reinforcement used as the main purpose of forming such a corner reinforced part 70, a resin with high viscosity and high thixotropic ratio (for example, viscosity of 30 Pa·S or more and a viscosity ratio of 3 or more) is used. By using the resin of such characteristics as the resin for reinforcement, the resin 7 for reinforcement after being discharged from the application nozzle 14a maintains a shape of the discharged state as it is substantially without fluidizing almost. Consequently, the resin 7 for reinforcement can form the resin reinforced part of a desired shape without fluidizing along the upper surface 5a.

In this drawing application, the application nozzle 14a is moved in a state of maintaining a predetermined clearance d laterally from the side surface 6b so that interference by contact with the side surface 6b does not occur as shown in FIG. 4(b). Further, it is desirable to set a height position from the upper surface 5a of the discharge orifice of the application nozzle 14a between a height Z1 indicating a height position of the lower surface 6d of the electronic component 6 and a height Z2 corresponding to one-half a thickness of the electronic component 6. By setting the height position of the discharge orifice of the application nozzle 14a thus, the discharged resin 7 for reinforcement can surely be brought into contact with the side surface 6b and the lower surface 6d of the electronic component 6 and reinforcement curing of the corner reinforced part 70 can be ensured.

In addition, in the example shown in FIG. 1, the resin 7 for reinforcement is applied using the electronic component mounting body 8 in which the electronic component 6 is already mounted on the substrate 5 before being conveyed into the resin application apparatus 1 as a target, but the target of application work by the resin application apparatus 1 is not limited to such an electronic component mounting body 8, and can also be used in use of previous application of the resin 7 for reinforcement to the substrate 5 in a step before the electronic component 6 is mounted, the so-called “previous application”.

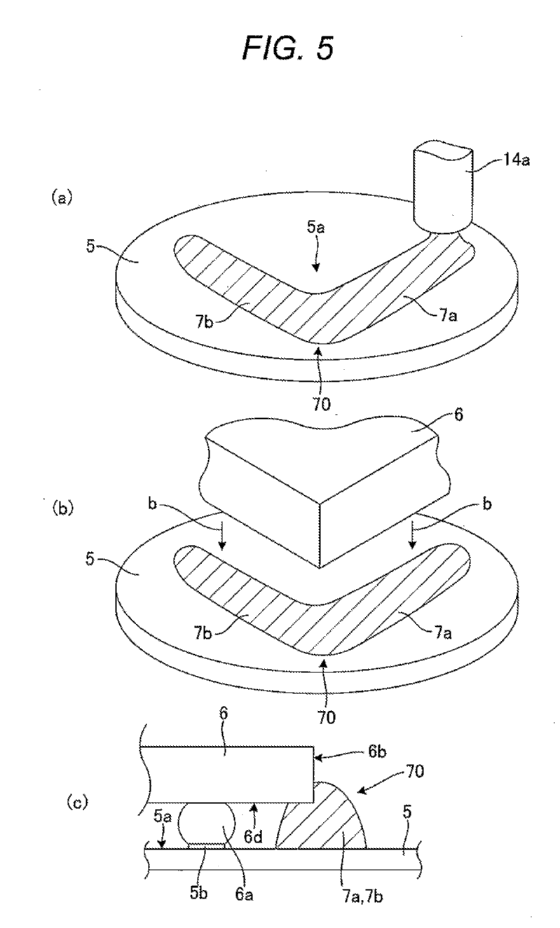

That is, as shown in FIG. 5(a), the corner reinforced part 70 made of the first resin line 7a and the second resin line 7b is previously formed by applying the resin to the upper surface 5a of the substrate 5 in a drawing manner by the application nozzle 14a in the step before the electronic component 6 is mounted. Subsequently, as shown in FIG. 5(b), the electronic component 6 is mounted on the substrate 5 in which the corner reinforced part 70 is formed. Consequently, as shown in FIG. 5(c), the corner reinforced part 70 made of the first resin line 7a and the second resin line 7b with a sectional shape similar to that of FIG. 4(b) is formed. By adopting such “previous application”, it is unnecessary to apply the resin in a state of outward offsetting the application nozzle 14a as shown in the example shown in FIG. 4(b), and there is an advantage capable of sufficiently bringing the resin 7 for reinforcement into contact with the lower surface 6d of the electronic component 6.

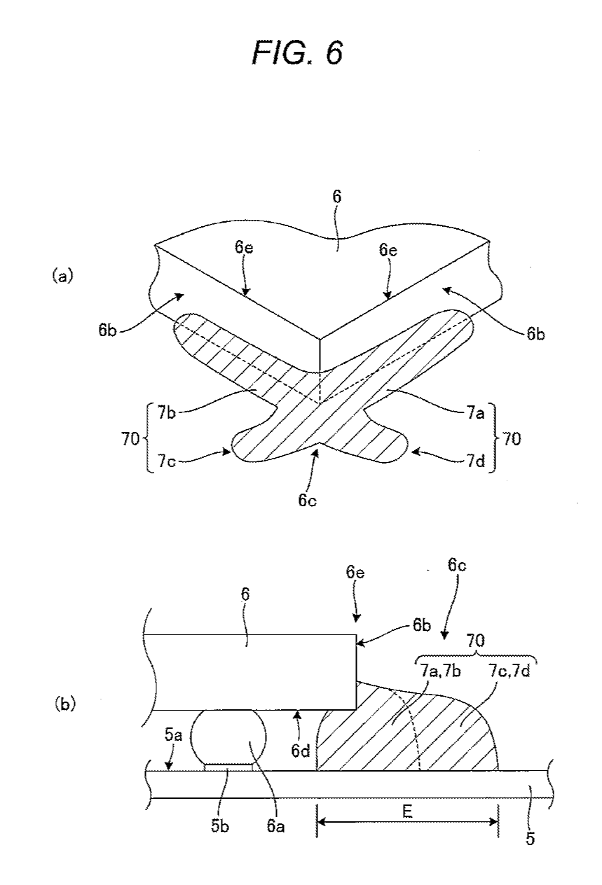

Also, FIG. 6 shows a shape of the corner reinforced part 70 in the pattern B shown in FIG. 3(b). In this case, the corner reinforced part 70 is formed in the shape having a spread larger than the pattern A in the vicinity of the corner part 6c. That is, as shown in FIG. 6(b), the first resin extension part 7c and the second resin extension part 7d in addition to the first resin line 7a and the second resin line 7b further extend from the corner part 6c, so that a fastening margin E fastened by contact between the upper surface 5a of the substrate 5 and the corner reinforced part 70 constructed by the resin lines and the resin extension parts can be widened and a reinforcement effect of the resin 7 for reinforcement in the corner part 6c improves dramatically as compared with the example shown in the pattern A.

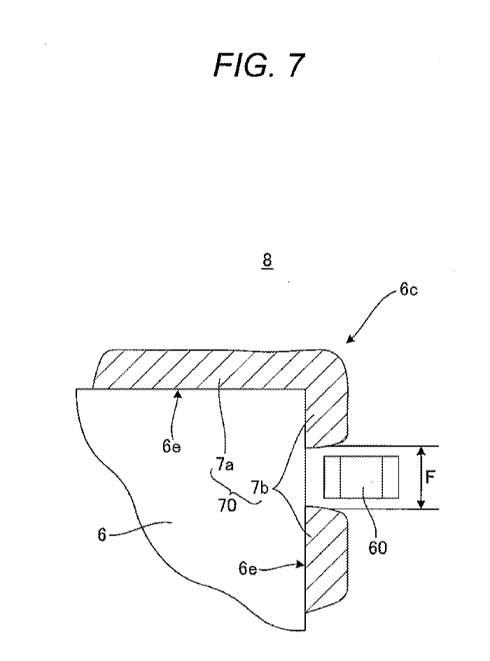

Also, the example shown in FIG. 7 shows an example of applying the invention in an example of mounting a miniature component 60 (the other electronic component) of a chip type such as an RC component in addition to an electronic component with bumps such as the electronic component 6 (one electronic component) on the substrate 5. In component arrangement of a circuit substrate, a relatively large-size functional component such as a BGA (Ball Grid Array) is first arranged and the miniature component 60 etc. are arranged in residual space. At this time, it is desirable to be arranged closest to the electronic component 6 as a position of the miniature component 60. However, when the used electronic component 6 is a component of a type necessary to dispose the corner reinforced part 70 as shown in FIG. 3, a range of reinforcement necessary to form the first resin line 7a or the second resin line 7b was conventionally forced to be excluded from a target area of arranging the miniature component 60 from the beginning.

That is, when the resin 7 for reinforcement is applied from an upper portion of the miniature component 60 mounted in the vicinity of the electronic component 6 and the miniature component 60 is partially covered with the resin 7 for reinforcement in the case of disposing the corner reinforced part 70 by each of the basic patterns shown in FIG. 3, an external force acts on the miniature component 60 by thermal expansion and contraction of the resin 7 for reinforcement at the time of a heat cycle and a fracture in a bonded part in which the electronic component 6 is bonded to the substrate 5 may be caused. Because of this, in the embodiment, when a component such as the electronic component 6 targeted for formation of the corner reinforced part 70 is closely installed together with a miniature component such as the miniature component 60, a part of the particular range (shown by arrow F) is designated as a mounting position of the miniature component 60 with respect to one or both of the first resin line 7a and the second resin line 7b formed in each of the four corner parts 6c by linearly applying the resin 7 for reinforcement along the outer edge 6e of the electronic component 6 as shown in FIG. 7. Then, this designated range is previously excluded from an application target of the resin 7 for reinforcement at a point in time of creating application data and a discontinuous part is disposed in the resin line. That is, the electronic component mounting body 8 shown in FIG. 7 has a form of disposing the discontinuous part in which the resin 7 for reinforcement is not applied to this electronic component 60 in a position of the presence of other electronic component 60 in the first resin line 7a and/or the second resin line 7b formed in the rectangular electronic component 6.

Next, a configuration of a control system of the resin application apparatus 1 will be described with reference to FIG. 8. An application operation control part 30 controls processing or an operation of each part constructing the resin application apparatus 1, and controls an application operation for which the electronic component 6 before the electronic component mounting body 8 or the substrate 5 is mounted is targeted. A storage part 31 stores various programs or data necessary for the application operation control part 30 to execute the application operation described above, and is constructed by a basic pattern storage part 31a, a position information storage part 31b, a component information storage part 31c and an application locus storage part 31d.

The basic pattern storage part 31a stores plural basic patterns with application shapes for forming the four corner reinforced parts 70 disposed in each of the four corner parts 6c in the rectangle of the targeted electronic component 6. The embodiment includes the patterns A, B and C shown in FIG. 3. The position information storage part 31b stores component position information indicating a position of the electronic component 6 in the electronic component mounting body 8. The component information storage part 31c stores component information including side sizes (side lengths a, b) of the electronic component 6. The application locus storage part 31d stores application locus data computed by the following locus computation part 32. Then, control of the resin application part 3 by the application operation control part 30 is performed based on the application locus data stored in the application locus storage part 31d.

A recognition processing part 33 recognizes and processes imaged data acquired by the camera 9. The embodiment is constructed so as to determine whether or not the application locus data is proper by superimposing an application locus computed by the locus computation part 32 on a screen in which the electronic component mounting body 8 conveyed into the conveyance part 2 is imaged by the camera 9 and displaying the application locus. A mechanism driving part 34 is controlled by the application operation control part 30, and drives the dispenser 14 which is the resin discharge unit, the nozzle up-and-down mechanism 14b incorporated into the dispenser 14, the Y-axis table 10 and the X-axis table 12 which are the movement unit.

An input part 35 is input unit such as a keyboard or a touch panel, and is used for inputting a manipulation command for executing an operation of the resin application apparatus 1 or a concrete dimension in the basic pattern necessary to create the application locus data computed by the locus computation part 32 in order to form the corner reinforced part 70, that is, a detailed dimension of each part varying depending on a kind of the targeted electronic component 6. A display park 36 is a display device such as a liquid crystal panel, and displays an image in which an operator visually determines whether or not a locus is proper in locus check processing described below or a guide screen at the time of input manipulation by the input part 35.

Here, details of the inputted concrete dimension will be described with reference to FIG. 9. FIG. 9(a) shows the concrete dimensions necessary to input in the case of targeting the electronic component mounting body 8 of a state of already mounting the electronic component 6 in a previous step. In addition, it is unnecessary to input the side lengths a, b (see FIG. 3) indicating sizes of the electronic component 6 herein since the side lengths are previously stored in the component information storage part 31c. First, lengths m and n of the first resin line 7a and the second resin line 7b are inputted as the basic concrete dimensions for prescribing a shape of the corner reinforced part 70. At this time, a proper clearance dimension d (see FIG. 3(b)) between the side surface 6b of the electronic component 6 and the application nozzle 14a and a diameter dimension D of the application nozzle 14a used together are inputted. Consequently, an offset dimension B (=d+D/2) from the first side 61 and the second side 62 to a first application line L1 and a second application line L2 in the case where the application nozzle 14a moves in drawing application is calculated uniquely. That is, in this case, the first application line L1 and the second application line L2 are respectively set outward separately from the first side 61 (one side) and the second side 62 (the other side) by a predetermined width corresponding to the offset dimension B.

Consequently, the application locus data by the drawing application for forming the first resin line 7a and the second resin line 7b are obtained with respect to one corner part 6c of one electronic component 6. That is, an application locus by drawing which ranges from a starting point P1 of the first application line L1 to a point P2 of intersection with the second application line L2 and further ranges to an ending point P3 of the second application line L2 is prescribed. Of course, an application locus opposite to this application direction, in which P3 is set at the starting point and P1 is set at the ending point, may be used. Then, application locus data on one electronic component 6 is created by applying this application locus data to each of the corner parts 6c. That is, coordinate values of P1, P2 and P3 in a coordinate system using a center point of the electronic component 6 as the origin are computed uniquely. Then, application locus data on all of one electronic component mounting body 8 is created by combining the application locus data on this electronic component 6 with position information stored in the position information storage part 31b, that is, mounting position information indicating position coordinates of the center point of the electronic component 6 in the substrate 5.

In addition, dimensions in which m1 and n1 are respectively outward added to m and n are inputted in order to respectively extend the first resin extension part 7c and the second resin extension part 7d outward from the corner part 6c from the first resin line 7a and the second resin line 7b in the case of targeting the pattern B shown in FIG. 3(b). Also, FIG. 9(b) shows an input example in the case of applying the basic pattern of the “previous application” shown in FIG. 5. In this case, only m and n similar to the case of targeting the pattern A could be inputted and in this case, the offset dimension B becomes 0. That is, the first application line L1 and the second application line L2 match with the first side 61 and the second side 62 of the electronic component 6. Thus, the embodiment has a form of inputting the length dimensions m and n of the first resin line 7a and the second resin line 7b as essential items as dimension data indicating the concrete dimension of the basic pattern necessary in the case of computing the application locus data by the locus computation part 32.

Next, application work processing of a resin for corner reinforced part using the solid electronic component 6 by the resin application apparatus 1 as a target will be described with reference to flows of FIGS. 10 and 11. First, an application mode is selected (ST1). That is, as shown in FIG. 4, application work for which the electronic component mounting body 8 in which the electronic component 6 is previously mounted is targeted or application work for which the substrate 5 before the electronic component 6 is mounted is targeted is selected. By this selection, a kind of the concrete dimension to be inputted in the subsequent dimension data input varies.

Next, the basic pattern is selected (ST2). That is, according to characteristics of the targeted electronic component 6, any of the patterns A, B and C shown in FIG. 3 is selected and is inputted from the input part 35. Subsequently, dimension data indicating the concrete dimension in the basic pattern is inputted (ST3). That is, each of the items shown in FIG. 9 is respectively inputted according to the selected basic pattern. Then, application locus data for which one electronic component mounting body 8 is targeted is created by the locus computation part 32 by combining these inputted dimension data, component information and position information respectively stored in the selected basic pattern storage part 31a, the component information storage part 31c and the position information storage part 31b.

Then, locus check processing for checking whether or not the application locus data computed in this manner is proper is executed (ST5). That is, in the case of only creating an application locus in only one corner part 6c and applying this application locus to the whole electronic component mounting body 8, unexpected trouble such as interference with other components or positional deviation caused by an input error may occur. Because of this, the embodiment adopts a method in which an operator visually determines the presence or absence of the trouble by superimposing the computed application locus data on arrangement of the electronic component 6 in the actual substrate 5.

This locus check processing will be described with reference to FIG. 11. First, the camera 9 is moved over an application target position (ST11). Next, the application target position is imaged by the camera 9 (ST12). Consequently, an image including the corner part 6c of the electronic component 6 targeted for application is acquired. Then, a resin line is displayed on the image of the application target position (ST13). That is, a shape of the resin line in consideration of an application width corresponding to the diameter dimension D of the application nozzle 14a based on the computed application locus data is displayed in a state of displaying the corner part 6c of the application target position on a display screen of the display part 36 and further matching a coordinate reference position on its image. Then, an operator visually observes the displayed resin line and when necessary, correction is made (ST14).

That is, it is visually determined whether or not the computed application locus data becomes a shape and a position suitable for the corner part 6c present in the application target position. Then, when positional deviation, a shape defect, etc. are observed, after the data is corrected, the locus check processing is again executed as necessary. In addition, only the application line (see the first application line L1 and the second application line L2 shown in FIG. 9) may be displayed simply instead of displaying the resin line in consideration of the application width.

In this manner, the locus check processing is completed and in the case of determining that the application locus data is proper, an application operation by drawing application for moving this application nozzle 14a while discharging the resin 7 for reinforcement from the application nozzle 14a is started in order to form each of the corner reinforced parts 70 (ST6). Then, the first resin line 7a with the length less than one-half the length of the one side including the corner part 6c in parallel with the first side 61 (one side) of the four sides constructing the rectangle of the electronic component 6 is formed (a first application step) (ST7). Then, the second resin line 7b including the corner part 6c in parallel with the second side 62 (the other side) orthogonal to the first side 61 is formed (a second application step) (ST8). Then, (ST7) and (ST8) are repeatedly executed with respect to all the corner parts 6c of all the electronic components 6 targeted.

When the application work for which the electronic component mounting body 8 in which the electronic component 6 is previously mounted is targeted is selected as the application mode in (ST1) herein, the application lines L1 and L2 of the first resin line 7a and the second resin line 7b are respectively set outward separately from the first side 61 and the second side 62 by the offset dimension B (a predetermined width) shown in FIG. 9 in the first application step and the second application step. Also, a height position from the upper surface 5a of the substrate 5 of the discharge orifice of the application nozzle 14a in the first application step and the second application step is set between a height position of the lower surface 6d of the electronic component 6 and a height position corresponding to one-half the thickness of the electronic component 6 (see FIG. 4(b)).

When the other miniature component 60 is already mounted in a position superimposed on any resin line of the corner reinforced part 70 of the electronic component 6 in the case of selecting any basic pattern herein, in the drawing application of the resin line, discharge of the resin 7 for reinforcement from the application nozzle 14a is interrupted in a mounting position of the miniature component 60 and the discontinuous part F shown in FIG. 7 is formed. That is, in this case, the discharge from the application nozzle 14a is interrupted so as not to apply the resin 7 for reinforcement to the miniature component 60 in a position of the presence of the miniature component 60 (the other electronic component) in the first application step and/or the second application step.

Then, in the case of selecting the pattern B shown in FIG. 3 as the basic pattern in (ST2), the first resin extension part 7c and the second resin extension part 7d are formed by being respectively extended by predetermined lengths in directions of the outside with respect to the corner part 6c from the first resin line 7a and the second resin line 7b in the first application step and the second application step. In addition, at this time, one of the first resin extension part 7c and the second resin extension part 7d is previously applied and when the subsequent resin extension part is formed, an application line of this resin extension part is formed in a form of being superimposed on the resin extension part formed previously.

As a result of this, in the case of moving the application nozzle 14a in order to form the subsequent resin extension part, a height of the discharge orifice of the application nozzle 14a must be adjusted in order to prevent interference between the application nozzle 14a and the previously applied resin extension part. That is, in this case, a height position of the discharge orifice of the application nozzle 14a in the subsequent application step of the first application step and the second application step is made higher than a height position of the discharge orifice of the application nozzle 14a in the previous application step.

In addition, in the processing flow shown in FIG. 10, the example in which computation processing of application locus data is performed by a computation function had by the resin application apparatus 1 and an application operation by drawing application is executed according to the computed application locus data by the same resin application apparatus 1 has been shown, but the resin application apparatus 1 may be allowed to function as a data creation apparatus for resin application. In this case, in the flow shown in FIG. 10, the application locus data after the locus check processing of (ST5) is completed is outputted (ST9). That is, the data is sent to other resin application apparatus through a storage medium etc. of a detachably conveyable type or an online output through a LAN system.

In this case, the resin application apparatus 1 functions as the data creation apparatus for resin application of a configuration including the position information storage part 31b, the component information storage part 31c, the basic pattern storage part 31a, the input part 35 for inputting the dimension data indicating the concrete dimension in the basic pattern and the locus computation part 32 shown in FIG. 8. Of course, a single data creation apparatus for resin application including the above configuration using a function of a personal computer etc. may be used. By using such a data method for resin application, data for the drawing application for which the corner part is targeted, necessary in the case of adopting the resin reinforcement method of the form of being limited to the corner part of the electronic component as described above, can be created efficiently.

Next, details of the resin application method for moving the application nozzle 14a along the preset application lines (see the first application line L1 and the second application line L2 shown in FIG. 9) and also discharging the resin 7 for reinforcement from the discharge orifice of the application nozzle 14a and linearly applying the resin for reinforcement in order to form the corner reinforced part 70 in the electronic component 6 as described above will be described with reference to FIGS. 12 and 13. In addition, an example of simply linearly applying the resin 7 for reinforcement is illustrated herein for the sake of simplicity, but the following process can be applied similarly in an application shape example of bending the resin line intermediately like the case of forming the corner reinforced part 70.

The resin with high viscosity and high thixotropic ratio is used as the resin 7 for reinforcement in the case of the purpose of forming the corner reinforced part 70 as described above. However, in such a resin with high viscosity and high thixotropic ratio, resin ends of both ends of the resin line tend to be formed in an upward protrusion shape in the case of discharging the resin from the application nozzle 14a and forming the resin line. When the resin ends of such an upward protrusion shape are present in the resin line formed for reinforcement of the corner part, a shape of the resin reinforced part becomes unstable and a reinforcement effect is impaired and also when the resin ends of the upward protrusion shape protrude from an upper surface of the electronic component targeted for reinforcement, this becomes a cause of various troubles, for example, occurrence of interference with other components or a cabinet in the case of being attached to the inside of the cabinet in a subsequent step. As a result of this, the resin application method for formation of the resin 7 for reinforcement shown in the embodiment solves this problem by the following method.

In FIG. 12, a broken line shown by numeral 7* shows an application shape line indicating an external shape of the resin line to be formed by drawing application by the application nozzle 14a, and the left side is an application start side endpoint ES and the right side is an application end side endpoint EE in FIG. 12. In the resin application method shown in the embodiment, rather than moving the application nozzle 14a to the discharge start side endpoint ES from the beginning and starting discharge of the resin 7 for reinforcement, in the case of starting the drawing application, the application nozzle 14a is positioned at a discharge start point Ps set in a position separate from the application start side endpoint ES of the endpoints of both sides of the application shape line 7* by a predetermined distance 11 on the application line as shown in FIG. 12(a). Next, as shown in FIG. 12(b), the application nozzle 14a is downward moved to a predetermined height prescribed by a desired resin line height dimension (arrow c) and discharge of the resin 7 for reinforcement is started from the discharge orifice of the application nozzle 14a (a discharge start step).

Then, after this discharge start step, the application nozzle 14a is moved to the application start side endpoint ES (arrow d) while continuing the discharge of the resin 7 for reinforcement as shown in FIG. 12(c) (a first nozzle movement step). At this time, a resin end 7e of an upward protrusion shape is formed at the discharge start point PS with a start of the discharge of the resin 7 for reinforcement. This resin end 7e is probably formed by the following resin behavior. That is, when the discharge of the resin 7 for reinforcement is started from the application nozzle 14a at the discharge start point PS, the resin 7 for reinforcement discharged from the discharge orifice swells just under the discharge orifice while keeping a block state without fluidizing in the periphery and becomes a state of adhering to a certain height along an outside surface of the application nozzle 14a. Then, when the application nozzle 14a moves in this state, the resin 7 for reinforcement adhering to a surface opposite to a movement direction is left and remains as the resin end 7e of the upward protrusion shape.

Then, after this first nozzle movement step, the application nozzle 14a is inverted at the discharge start side endpoint ES and is moved toward the application end side endpoint EE opposite to the application start side endpoint ES along the application shape line 7* while continuing the discharge of the resin 7 for reinforcement as shown in FIG. 12(d) (a second nozzle movement step). In this second nozzle movement step, the application nozzle 14a moves through the discharge start point PS, so that the resin end 7e of a state of remaining in the upward protrusion shape at the discharge start point PS is leveled by the application nozzle 14a and disappears.

Also in an end period of this second nozzle movement step, as shown in FIG. 13(a), the application nozzle 14a is downward moved at a downward movement start point PD set in a position separate from the application end side endpoint EE by a predetermined distance 12 on the application shape line 7* and the application nozzle 14a is moved to the discharge end side endpoint EE in this state. Then, as shown in FIG. 13(b), the discharge of the resin 7 for reinforcement from the discharge orifice is stopped at timing at which the application nozzle 14a reaches the application end side endpoint EE (a discharge stop step).

Then, subsequently, as shown in FIG. 13(c), the application nozzle 14a is upward moved (arrow h) and at this time, the discharge orifice of the application nozzle 14a once downward moves to a position lower than a height of the resin line to be formed, so that the resin 7 for reinforcement upward moving with the state of adhering to the discharge orifice with upward movement of the application nozzle 14a is torn in a height position of substantially the same level as the height of the resin line formed already, and an upper end of a resin end 7f formed at the discharge end side endpoint EE does not exceed the height of the already formed resin line greatly. Consequently, the resin line ranging from the discharge start side endpoint ES to the discharge end side endpoint EE is formed by linearly applying the resin 7 for reinforcement as shown in FIG. 13(d).

In the resin line formed in this manner, the resin end 7e of the upward protrusion shape formed with the start of the discharge of the resin 7 for reinforcement from the application nozzle 14a at the discharge start point PS is leveled by movement of the application nozzle 14a in the second nozzle movement step, so that the resin end 7e of the upward protrusion present at the discharge start side endpoint ES is normally caused to disappear. Also, in the second nozzle movement step, the application nozzle 14a is downward moved at the downward movement start point set in the position PD separate from the application end side endpoint EE by the predetermined distance 12 on the application line. Consequently, the resin end 7f of the upward protrusion shape is prevented from being formed with the stop of the discharge of the resin 7 for reinforcement from the application nozzle 14a.

Such resin ends 7e, 7f of the upward protrusion shape in the corner reinforced part 70 formed for reinforcement of the corner part 6c impair a reinforcement effect and also when the resin ends 7e, 7f protrude from an upper surface of the electronic component 6 targeted for reinforcement, this becomes a cause of various troubles, for example, occurrence of interference with other components or a cabinet in the case of being attached to the inside of the cabinet in a subsequent step. On the other hand, by applying the resin application method shown in the embodiment, the resin ends of the upward protrusion shape can effectively be prevented from being formed even in the case of using the resin 7 for reinforcement with high viscosity and high thixotropic ratio for the corner reinforced part of the electronic component 6.

The invention has been described in detail with reference to the specific embodiment, but it is apparent to those skilled in the art that various changes or modifications can be made without departing from the spirit and scope of the invention.

The present application is based on Japanese patent application (patent application No. 2009-037488) filed on Feb. 20, 2009, and the contents of the patent application are hereby incorporated by reference.

### INDUSTRIAL APPLICABILITY

A resin application apparatus and a data creation apparatus for resin application of the invention have characteristics capable of efficiently doing resin application work for resin reinforcement for which a corner part of an electronic component is targeted, and are useful in a field of linearly applying a resin for reinforcement along an outer edge of the electronic component in an electronic component mounting body made by mounting the electronic component on a substrate.

### DESCRIPTION OF REFERENCE NUMERALS AND SIGNS

1 RESIN APPLICATION APPARATUS
2 CONVEYANCE PART
3 RESIN APPLICATION PART
5 SUBSTRATE
6 ELECTRONIC COMPONENT
6a BUMP
6c CORNER PART
6e OUTER EDGE
60 MINIATURE COMPONENT
61 FIRST SIDE
62 SECOND SIDE
7 RESIN FOR REINFORCEMENT
7a FIRST RESIN LINE
7b SECOND RESIN LINE
7c FIRST RESIN EXTENSION PART
7d SECOND RESIN EXTENSION PART
7e RESIN END
7f RESIN END
7* APPLICATION SHAPE LINE
8 ELECTRONIC COMPONENT MOUNTING BODY
10 Y-AXIS TABLE (MOVEMENT UNIT)
12 X-AXIS TABLE (MOVEMENT UNIT)
13 RESIN TANK (RESIN DISCHARGE UNIT)
14 DISPENSER (RESIN DISCHARGE UNIT)
14a APPLICATION NOZZLE
L1 FIRST APPLICATION LINE
L2 SECOND APPLICATION LINE
ES DISCHARGE START SIDE ENDPOINT
EE DISCHARGE END SIDE ENDPOINT

1-4. (canceled)

5. A resin application apparatus for linearly applying a resin for reinforcement along an outer edge of an electronic component in an electronic component mounting body in which the electronic component having a planar shape of a rectangle is mounted on a substrate or the substrate before the electronic component is mounted, the resin application apparatus comprising:
a resin discharge unit which discharges the resin for reinforcement from a discharge orifice of an application nozzle;
a movement unit which moves the application nozzle relatively to the electronic component mounting body;
a position information storage part which stores component position information indicating a position of the electronic component in the electronic component mounting body;
a component information storage part which stores component information including a side size of the electronic component;
a basic pattern storage part which stores plural basic patterns with application shapes for forming four corner reinforced parts disposed in each of four corner parts in the rectangle;
an input part which inputs dimension data indicating a concrete dimension in the basic pattern, a locus computation part for computing application locus data for moving the application nozzle and applying the resin for reinforcement based on the position information, the component information, the basic patterns and the dimension data; and
an application operation control part for controlling the resin discharge unit and the movement unit based on the application locus data,
wherein the corner reinforced part is constructed by a first resin line set in parallel with one side of four sides in the rectangle and formed by applying the resin for reinforcement in a drawing manner in a step before the electronic component is mounted along a first application line including said corner part, and a second resin line set in parallel with the other side orthogonal to the one side and formed by applying the resin for reinforcement in a drawing manner in the step before the electronic component is mounted along a second application line including said corner part, and length dimensions of the first resin line and the second resin line are inputted as the dimension data.

6. The resin application apparatus as claimed in claim 5, wherein the first application line and the second application line are respectively set outward separately from the one side and the other side by a predetermined width.

7. A data creation apparatus for resin application, comprising:
a resin discharge unit which discharges a resin for reinforcement from a discharge orifice of an application nozzle;
a movement unit which moves the application nozzle relatively to an electronic component mounting body in which an electronic component having a planar shape of a rectangle is mounted on a substrate or the substrate before the electronic component is mounted; and
an application operation control part which controls the resin discharge unit and the movement unit, the data creation apparatus which is used in a resin application apparatus for linearly applying the resin for reinforcement along an outer edge of the electronic component in the electronic component mounting body or the substrate before the electronic component is mounted and creates application locus data for moving the application nozzle and applying the resin for reinforcement,
wherein the data creation apparatus comprises:
a position information storage part for storing component position information indicating a position of the electronic component in the electronic component mounting body;
a component information storage part for storing component information including a side size of the electronic component, a basic pattern storage part for storing plural basic patterns with application shapes for forming four corner reinforced parts disposed in each of four corner parts in the rectangle;
an input part for inputting dimension data indicating a concrete dimension in the basic pattern; and
a locus computation part which computes the application locus data for moving the application nozzle and applying the resin for reinforcement based on the position information, the component information, the basic patterns and the dimension data, and the corner reinforced part is constructed by a first resin line set in parallel with one side of four sides in the rectangle and formed by applying the resin for reinforcement in a drawing manner in a step before the electronic component is mounted along a first application line including said corner part, and a second resin line set in parallel with the other side orthogonal to the one side and formed by applying the resin for reinforcement in a drawing manner in the step before the electronic component is mounted along a second application line including said corner part, and length dimensions of the first resin line and the second resin line are inputted as the dimension data.

8. The data creation apparatus for resin application as claimed in claim 7, wherein the first application line and the second application line are respectively set outward separately from the one side and the other side by a predetermined width.
